(19) United States
(12) Patent Application Publication
(10) Pub. No.: US 2013/0108889 A1
(43) Pub. Date: May 2, 2013

(54) Magnetoresistance Device and Memory Device Including the Magnetoresistance Device

(71) Applicant: Agency for Science, Technology and Research, Singapore (SG)

(72) Inventors: Seidikkurippu Nellainayagam PIRAMANAYAGAM, Singapore (SG); Rachid SBIAA, Singapore (SG); Taiebeh TAHMASEBI, Singapore (SG)

(73) Assignee: AGENCY FOR SCIENCE, TECHNOLOGY AND RESEARCH, Singapore (SG)

(21) Appl. No.: 13/660,500

(22) Filed: Oct. 25, 2012

Related U.S. Application Data
(60) Provisional application No. 61/551,959, filed on Oct. 27, 2011.

(51) Int. Cl. G11B 5/39

(52) U.S. Cl. 428/811.2

(57) ABSTRACT

According to embodiments of the present invention, a magnetoresistance device is provided. The magnetoresistance device includes a hard magnetic layer and a soft magnetic layer arranged one over the other, wherein the soft magnetic layer includes a stack structure, the stack structure including a first layer and a second layer arranged one over the other, wherein the first layer has a first damping factor and the second layer has a second damping factor, the first damping factor is selected to be lower than the second damping factor.

### CROSS-REFERENCE TO RELATED APPLICATION

This application claims the benefit of priority of U.S. provisional application No. 61/551,959, filed 27 Oct. 2011, the contents of which are incorporated herein by reference for all purposes.

### TECHNICAL FIELD

Various embodiments relate to a magnetoresistance device. Further embodiments relate to a memory device including the magnetoresistance device and a sensor including the magnetoresistance device.

### BACKGROUND

Giant magnetoresistive (GMR) spin valves (SV) include two ferromagnetic layers separated by a metallic spacer layer. They exhibit large changes in resistance at different values of applied fields. This effect can be applied in memory elements for magnetic random access memory (MRAM) as well as read-head sensors for hard disk drives (HDD). For example, a state with a high resistance can be considered as ‘1’ and a state with a lower resistance as ‘0’, for digital recording in a memory device. In order to distinguish the ‘0’ and ‘1’ states, free from the noise voltage, it is essential that they exhibit a high magnetoresistance. A larger magnetoresistance (MR) signal has been found in devices with a magnetic tunnel junction (MTJ), where the magnetoresistance occurs due to the tunneling of electrons through the insulator layer between the ferromagnetic layers. The tunneling magnetoresistance (TMR) in MTJs is reported to be larger than GMR. Therefore, MTJ devices are considered for MRAM applications.

Magnetic random access memory (MRAM) is emerging as an alternative to conventional semiconductor memories. Compared to static random-access memory (SRAM) and dynamic random-access memory (DRAM), the MRAM has an advantage of non-volatility. Compared to flash memory used for storage of information, the MRAM has endurance as an advantage. In order to compete with flash memory, it is necessary to increase the density of the MRAM cells in a chip, which involves keeping the MRAM cells as small as possible. In order to compete with SRAM and DRAM, the speed of operation without compromising the density is the key.

As compared to field-switchable MRAM devices, the recently popular spin-transfer torque (STT) based MRAMs are potentially scalable to very small sizes (5 nm of FePt material, based on the thermal stability considerations only). However, the smallest possible cell size is not only limited by thermal stability, but also by the writability. Devices with FePt may require a large write current for the write operation. In the case of STT-MRAM, there are two geometries—one with magnetization in plane and another with magnetization out-of-plane (perpendicular). While the former seems to be useful at entry level, the latter seems to be more promising for future, especially from magnetization reversal and thermal stability perspectives.

For the MRAM with a perpendicular geometry, materials with a high perpendicular anisotropy such as ordered L1₀-FePt are considered as potential candidates. While they are good for the hard layers of the MRAM devices (that retain their magnetization direction), their use as the soft layer is questionable. Devices based on FePt layers have a high anisotropy constant and hence they can retain their magnetization in a stable manner. However, as the writing current is also proportional to the anisotropy constant, they need a high current to switch their magnetization, posing a limitation in the transistor size (or the density of cells) or in the operating speed. Materials with a lower anisotropy constant or lower damping factor, such as CoFe, multilayers of CoFe/Pd may be used as soft layers. However, the use of such materials also decreases the writing speed, as the writing speed is proportional to the damping constant.

FIG. 1A shows a schematic view of a conventional magnetoresistance device 100 with a single spin-valve structure. The magnetoresistance device 100 includes a hard magnetic layer 101 of (Pd/CoFe)₄ multilayers with a magnetization orientation as indicated by the arrow within the hard magnetic layer 101, and a soft magnetic layer 102 of (CoFe/Pd)₂ multilayers with a magnetization orientation as indicated by the arrow within the soft magnetic layer 102. The hard magnetic layer 101 and the soft magnetic layer 102 are separated by a layer structure 103 of CoFe/Cu/CoFe. The layer structure 103 includes a copper (Cu) layer to achieve magnetoresistance. However, the Cu layer may instead be replaced by an insulator layer such as a layer of aluminium oxide (AlO) or magnesium oxide (MgO). The layer structure 103 also includes spin-filter CoFe layers adjacent to the Cu spacer layer. The magnetoresistance device 100 further includes a layer of tantalum (Ta) 104 and a layer of palladium (Pd) 105 on top of the hard magnetic layer 101, and a layer of tantalum (Ta) 106 and a layer of palladium (Pd) 107, acting as seed layers, beneath the soft magnetic layer 102.

FIG. 1B shows a schematic view of a conventional magnetoresistance device 120 with a dual spin-valve structure. The magnetoresistance device 120 includes a first hard magnetic layer 121 of (CoFe/Pd)₄ multilayers with a magnetization orientation as indicated by the arrow within the hard magnetic layer 121, a second hard magnetic layer 122 (Pd/CoFe)₄ multilayers with a magnetization orientation as indicated by the arrow within the second hard magnetic layer 122, and a soft magnetic layer 123 of (Pd/CoFe)₂ multilayers and a Pd layer, with a magnetization orientation as indicated by the arrow within the soft magnetic layer 123.

The first hard magnetic layer 121 and the soft magnetic layer 123 are separated by a layer structure 124 of CoFe/Cu/CoFe. The layer structure 124 includes a copper (Cu) layer to achieve magnetoresistance. However, the Cu layer may instead be replaced by an insulator layer such as a layer of aluminium oxide (AlO) or magnesium oxide (MgO). The layer structure 124 also includes spin-filter CoFe layers adjacent to the Cu spacer layer.

The second hard magnetic layer 122 and the soft magnetic layer 123 are separated by a layer structure 125 of CoFe/Cu/CoFe. The layer structure 125 includes a copper (Cu) layer to achieve magnetoresistance. However, the Cu layer may instead be replaced by an insulator layer such as a layer of aluminium oxide (AlO) or magnesium oxide (MgO). The layer structure 125 also includes spin-filter CoFe layers adjacent to the Cu spacer layer.

The magnetoresistance device 120 further includes a layer of tantalum (Ta) 126 and a layer of palladium (Pd) 127 on top of the second hard magnetic layer 122, and a layer of tantalum (Ta) 128 and a layer of palladium (Pd) 129, acting as seed layers, beneath the first hard magnetic layer 121.

As shown in FIGS. 1A and 1B, the soft magnetic layers 102, 123 as well as the hard magnetic layers 101, 121, 122, possess only one type of layer structure of (CoFe/Pd) multilayers. While the thickness of the CoFe/Pd multilayers can been varied to change the magnetization reversal field (or current) of the different layers, it is difficult to predict the coercivity values at a device level (after patterning).

### SUMMARY

According to an embodiment, a magnetoresistance device is provided. The magnetoresistance device may include a hard magnetic layer and a soft magnetic layer arranged one over the other, wherein the soft magnetic layer includes a stack structure, the stack structure including a first layer and a second layer arranged one over the other, wherein the first layer has a first damping factor and the second layer has a second damping factor, the first damping factor is selected to be lower than the second damping factor.

According to an embodiment, a memory device is provided. The memory device may include the magnetoresistance device as described above.

According to an embodiment, a sensor is provided. The sensor may include the magnetoresistance device as described above.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1A shows a schematic view of a conventional magnetoresistance device with a single spin-valve structure.

FIG. 1B shows a schematic view of a conventional magnetoresistance device with a dual spin-valve structure.

FIG. 2A shows a schematic block diagram of a magnetoresistance device, while FIG. 2B shows a simplified cross-sectional representation of the magnetoresistance device of the embodiment of FIG. 2A, according to various embodiments.

FIG. 3A shows a schematic view of a magnetoresistance device, according to various embodiments, while FIG. 3B shows an embodiment of the magnetoresistance device of FIG. 3A.

FIG. 3C shows a schematic view of a magnetoresistance device, according to various embodiments, while FIG. 3D shows an embodiment of the magnetoresistance device of FIG. 3C.

FIG. 4A shows a schematic view of a magnetoresistance device, according to various embodiments, while FIG. 4B shows an embodiment of the magnetoresistance device of FIG. 4A.

FIG. 4C shows a schematic view of a magnetoresistance device, according to various embodiments, while FIG. 4D shows an embodiment of the magnetoresistance device of FIG. 4C.

FIG. 4E shows an embodiment of the magnetoresistance device of FIG. 4A.

FIG. 5 shows a plot of magnetization reversal characteristics of the embodiment of FIG. 4E.

FIG. 6 shows a plot of minor loops corresponding of the embodiment of FIG. 4E.

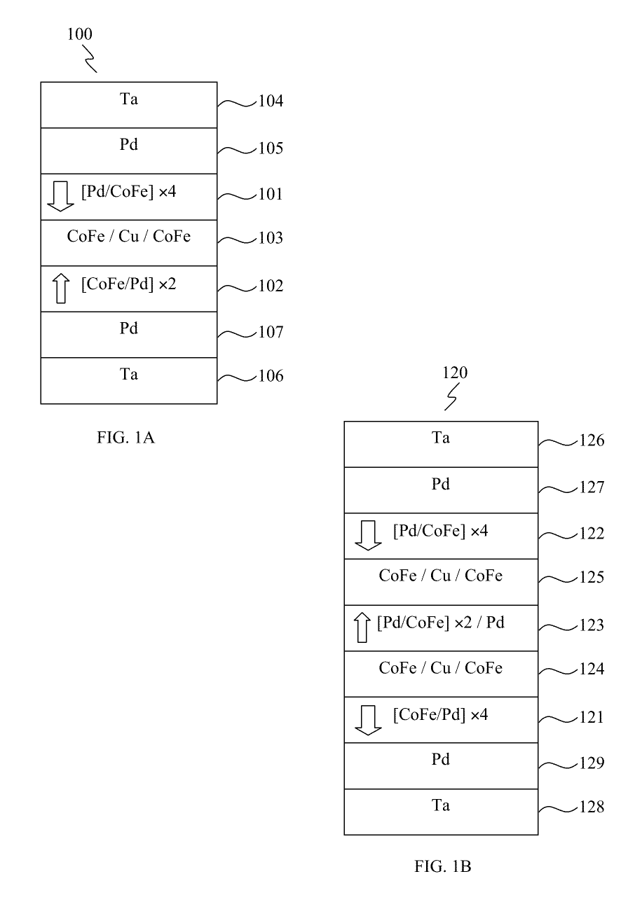

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the devices are analogously valid for the other device.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the phrase “at least substantially” may include “exactly” and a reasonable variance.

In the context of various embodiments, the term “about” or “approximately” as applied to a numeric value encompasses the exact value and a reasonable variance.

As used herein, the term “and/or” includes any and all combinations of one or more of the associated listed items.

Various embodiments relate to a non-volatile magnetic memory device, for example a magnetoresistive random access memory (MRAM).

Various embodiments may provide a magnetoresistance device or a magnetoresistive device. Various embodiments may provide a multi-bit per cell magnetoresistive device (e.g. a magnetic memory element) with spin torque switching. The magnetoresistive device may be a giant magnetoresistive (GMR) device or a tunnel magnetoresistive (TMR) device.

In various embodiments, the magnetoresistance device or the magnetoresistive device may include a single spin valve (S-SV) or a dual spin valve (D-SV). In various embodiments, the magnetoresistive device may include or may be a tunnel magnetoresistive (TMR) device, which may include a single tunnel junction (S-MTJ) or dual tunnel junctions (D-MTJ). However, it should be appreciated that the magnetoresistance device or the magnetoresistive device of various embodiments may include any number of spin valves, e.g. three (i.e. triple spin valve (T-SV)), four, five or any higher number, or any number of magnetic tunnel junction structures, e.g. three (i.e. triple magnetic tunnel junction (T-MTJ)), four, five or any higher number.

Various embodiments may provide a magnetoresistance device that may enable switching magnetization by a spin torque effect, and a method for switching magnetization by the spin torque effect. The spin torque effect enables the magnetization orientation, for example of a magnetic layer, in the S-SV, in the D-SV, in the S-MTJ, or in the D-MTJ to be switched by using a spin-polarized current or a spin transfer current.

Various embodiments may provide a magnetoresistance device with a low magnetization reversal current and high speed and a method of manufacturing such a magnetoresistance device.

Various embodiments of the magnetoresistance device may include materials and/or arrangements (e.g. layer arrangements and/or stack arrangements of layers) that may be suitable for MRAM applications which may help to reduce the magnetization reversal current without significantly affecting the speed. Various embodiments may provide an arrangement with materials having two different damping factors (high and low) as an approach to achieve optimized values of magnetization reversal current and magnetization reversal speed or a balance between the magnetization reversal current and magnetization reversal speed.

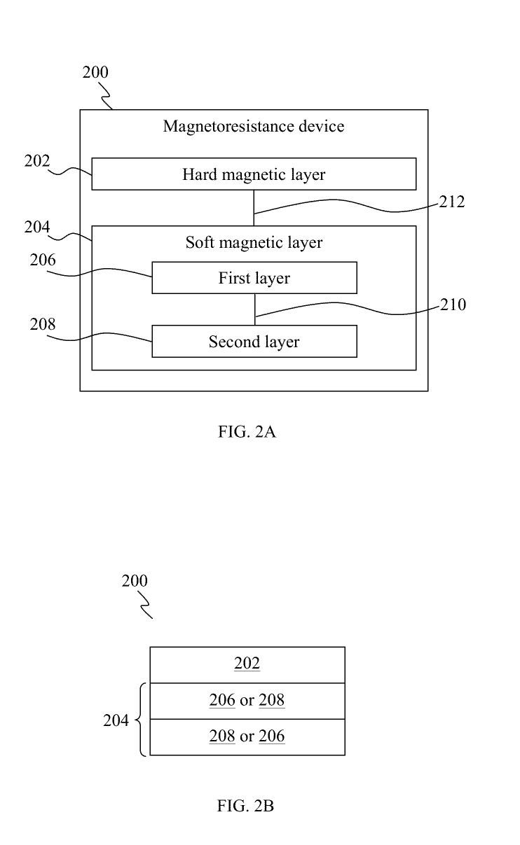

FIG. 2A shows a schematic block diagram of a magnetoresistance device 200, while FIG. 2B shows a simplified cross-sectional representation of the magnetoresistance device 200 of the embodiment of FIG. 2A, according to various embodiments. The magnetoresistance device 200 includes a hard magnetic layer (or hard layer or ferromagnetic hard layer) 202 and a soft magnetic layer (or soft layer or ferromagnetic soft layer) 204 arranged one over the other, wherein the soft magnetic layer 204 includes a stack structure, the stack structure including a first layer 206 and a second layer 208 arranged one over the other, wherein the first layer 206 has a first damping factor and the second layer 208 has a second damping factor, the first damping factor is selected to be lower than the second damping factor. The soft magnetic layer 204 may have an overall damping factor lower than that of the hard magnetic layer 202. The hard magnetic layer 202 and the soft magnetic layer 204 may form or may be part of a magnetic junction of the magnetoresistance device 200. The hard magnetic layer 202 and the soft magnetic layer 204 may be arranged in a stack structure or arrangement.

In various embodiments, the first layer 206 may have a damping factor that is lower than a damping factor of the second layer 208. As non-limiting examples, the second layer 208 may include a high damping factor material, for example cobalt-palladium (Co/Pd) multilayers or iron-platinum (FePt) layers, which may retain their magnetization in an at least substantially stable manner. The first layer 206 may include a material with a lower damping factor, for example cobalt-iron (CoFe), cobalt-iron-boron (CoFeB), or multilayers of cobalt-iron/palladium (CoFe/Pd) or cobalt-iron-boron/palladium (CoFeB/Pd).

In FIG. 2A, the line represented as 210 is illustrated to show the relationship between the first layer 206 and the second layer 208, which may include electrical coupling and/or mechanical coupling, while the line represented as 212 is illustrated to show the relationship between the hard magnetic layer 202 and the soft magnetic layer 204, which may include electrical coupling and/or mechanical coupling. In various embodiments, the coupling between the hard magnetic layer 202 and the soft magnetic layer 204 may be achieved through the use of one or more spacer layers which may include a metal such as copper (Cu) or an insulator such as aluminium oxide (AlOₓ) or magnesium oxide (MgO).

As shown in FIG. 2B, the hard magnetic layer 202 and the soft magnetic layer 204 may be arranged one over the other. For example, the soft magnetic layer 204 may be arranged beneath the hard magnetic layer 202, as shown in FIG. 2B, or the hard magnetic layer 202 may be arranged beneath the soft magnetic layer 204.

As shown in FIG. 2B, the first layer 206 and the second layer 208 of the soft magnetic layer 204 may be arranged one over the other. For example, the first layer 206 may be arranged on top of the second layer 208, or the second layer 208 may be arranged on top of the first layer 206.

In various embodiments, the first layer 206 includes a material including but not limited to any one of or a combination of cobalt (Co), iron (Fe), nickel (Ni), boron (B), nitrogen (N) or an alloy including at least one of cobalt (Co), iron (Fe) or nickel (Ni).

In the context of various embodiments, the first layer 206 may include at least one first bilayer structure, wherein a layer of the at least one first bilayer structure includes a material including but not limited to any one of or a combination of cobalt (Co), iron (Fe), boron (B), or nickel (Ni), and another layer of the at least one first bilayer structure includes a material including but not limited to any one of or a combination of palladium (Pd), platinum (Pt) or nickel (Ni). In various embodiments, a thickness of the layer including any one of or a combination of cobalt (Co), iron (Fe), boron (B), or nickel (Ni), of the at least one bilayer structure may be between about 0.2 nm and about 1 nm, e.g. between about 0.2 nm and about 0.8 nm, between about 0.2 nm and about 0.5 nm or between about 0.5 nm and about 1 nm.

For example, the first layer 206 may include a bilayer or a multilayer of (Co/X), (CoFe/X) or (CoFeB/X), where X may be palladium (Pd), platinum (Pt), an alloy of Pd and Pt, or nickel (Ni). Any combination of different bilayer structures or multilayer structures, e.g. (Co/X) and (CoFe/X), may also be provided. As a non-limiting example, the first layer 206 may include (CoFeB/Pd)₅, of 5 layers of CoFeB arranged alternately with 5 layers of Pd, i.e. (CoFeB/Pd/CoFeB/Pd/CoFeB/Pd/CoFeB/Pd/CoFeB/Pd).

In various embodiments, the second layer 208 includes a material including but not limited to any one of or a combination of iron-platinum (FePt), cobalt-platinum (CoPt), cobalt-palladium (CoPd) or an alloy including at least one of cobalt (Co), iron (Fe), nickel (Ni), platinum (Pt) or palladium (Pd).

In the context of various embodiments, the second layer 208 may include at least one second bilayer structure, wherein a layer of the at least one second bilayer structure includes a material including but not limited to any one of or a combination of cobalt (Co), iron (Fe) or nickel (Ni), and another layer of the at least one second bilayer structure includes any one of or a combination of palladium (Pd), nickel (Ni) or platinum (Pt). In various embodiments, a thickness of the layer including any one of or a combination of cobalt (Co), iron (Fe), or nickel (Ni), of the at least one second bilayer structure may be between about 0.2 nm and about 1 nm, e.g. between about 0.2 nm and about 0.8 nm, between about 0.2 nm and about 0.5 nm or between about 0.5 nm and about 1 nm.

For example, the second layer 208 may include a bilayer or a multilayer of (Co/X) or (CoFe/X), where X may be palladium (Pd), platinum (Pt), an alloy of Pd and Pt, or nickel (Ni). Any combination of different bilayer structures or multilayer structures, e.g. (Co/X) and (CoFe/X), may also be provided. As a non-limiting example, the second layer 208 may include (CoFe/Pd)₅, of 5 layers of CoFe arranged alternately with 5 layers of Pd, i.e. (CoFe/Pd/CoFe/Pd/CoFe/Pd/CoFe/Pd/CoFe/Pd).

In the context of various embodiments, the soft magnetic layer 204 may have a thickness in a range of between about 0.3 nm and about 10 nm, for example between about 0.3 nm and about 8 nm, between about 0.3 nm and about 5 nm, between about 0.3 nm and about 2 nm, between about 0.3 nm and about 1 nm, between about 1 nm and about 10 nm, between about 1 nm and about 8 nm, between about 1 nm and about 4 nm, between about 2 nm and about 10 nm, or between about 4 nm and about 6 nm.

In various embodiments, the magnetoresistance device 200 may further include a third layer between the first layer 206 and the second layer 208, wherein the third layer is configured to control the exchange coupling between the first layer 206 and the second layer 208. In various embodiments, the exchange coupling may be controlled from positive, through zero, to negative.

In the context of various embodiments of the magnetoresistance device 200, the stack structure may include a plurality of the first layers 206 and a plurality of the second layers 208 such that each first layer 206 and each second layer 208 are arranged alternately. In other words, the soft magnetic layer 204 of the magnetoresistance device 200 may include a repeating arrangement of the first layers 206 and the second layer 208, e.g. a sequential arrangement of the first layer 206, the second layer 208, the first layer 206, the second layer 208, etc., depending on the number of repeating arrangement. It should be appreciated that the positioning of the plurality of the first layers 206 and the plurality of the second layers 208 may be interchangeable.

In various embodiments, the magnetoresistance device 200 may further include a plurality of third layers, each third layer being arranged between each first layer 206 and each second layer 208, wherein each third layer is configured to control the exchange coupling between each first layer 206 and each second layer 208. In other words, the magnetoresistance device 200 may include a repeating arrangement of the first layers 206, the third layers and the second layer 208, e.g. a sequential arrangement of the first layer 206, the third layer, the second layer 208, the first layer 206, the third layer, the second layer 208, etc., depending on the number of repeating arrangement. Therefore, a respective third layer is sandwiched between a pair of the respective first layer 206 and the respective second layer 208, where the third layer is configured to control the exchange coupling between the pair of first layer 206 and second layer 208 sandwiching the third layer. In various embodiments, the exchange coupling may be controlled from positive, through zero, to negative. It should be appreciated that the positioning of the plurality of the first layers 206 and the plurality of the second layers 208 may be interchangeable.

In the context of various embodiments, any one of or each of the third layer may include a material including but not limited to any one of ruthenium (Ru), rhodium (Rh), copper (Cu), chromium (Cr), iridium (Ir), silver (Ag), gold (Au), palladium (Pd), platinum (Pt), cobalt (Co) or an alloy of any two or more of these materials. The thickness of each third layer may be in the range of between about 0.4 nm and about 3 nm, e.g. between about 0.4 nm and about 2 nm, between about 0.4 nm and about 1 nm, between about 1 nm and about 3 nm or between about 1 nm and about 2 nm.

In various embodiments, the hard magnetic layer 202 includes at least one material including but not limited to iron (Fe), platinum (Pt), cobalt (Co), palladium (Pd), germanium (Ge), phosphorous (P), nickel (Ni) or an alloy including at least one of iron (Fe), platinum (Pt), cobalt (Co), palladium (Pd), germanium (Ge), phosphorous (P), or nickel (Ni).

In further embodiments, the hard magnetic layer 202 includes at least one third bilayer structure, wherein a layer of the at least one third bilayer structure includes a material including but not limited to any one of or a combination of cobalt (Co), nickel (Ni) and iron (Fe), and another layer of the at least one third bilayer structure includes a material including but not limited to any one of or a combination of platinum (Pt), palladium (Pd) or an alloy including at least one of platinum (Pt) or palladium (Pd).

For example, the hard magnetic layer 202 may include a bilayer or a multilayer of (Co/X) or (CoFe/X) where X is palladium (Pd), platinum (Pt) or an alloy of Pd and Pt. Any combination of different bilayer structures or multilayer structures, e.g. (Co/X) and (CoFe/X), may also be provided. As a non-limiting example, the hard magnetic layer 202 may include (CoFe/Pd)₅, of 5 layers of CoFe arranged alternately with 5 layers of Pd, i.e. (CoFe/Pd/CoFe/Pd/CoFe/Pd/CoFe/Pd/CoFe/Pd).

In the context of various embodiments, the hard magnetic layer 202 may have a thickness in a range of between about 0.3 nm and about 10 nm, for example between about 0.3 nm and about 8 nm, between about 0.3 nm and about 5 nm, between about 0.3 nm and about 2 nm, between about 0.3 nm and about 1 nm, between about 1 nm and about 10 nm, between about 1 nm and about 8 nm, between about 1 nm and about 4 nm, between about 2 nm and about 10 nm, or between about 4 nm and about 6 nm.

In various embodiments, the magnetoresistance device 200 may further include a spacer layer disposed between the hard magnetic layer 202 and the soft magnetic layer 204. The spacer layer may include or may be of a material including but not limited to a conductive and non-magnetic material (e.g. a conductor), a non-conductive and non-magnetic material, or an insulator material.

In the context of various embodiments, the spacer layer may include a conductive and non-magnetic material including but not limited to any one of or any combination of copper (Cu), silver (Ag), gold (Au), tantalum (Ta), chromium (Cr), palladium (Pd), platinum (Pt) or ruthenium (Ru). By arranging a conductive and non-magnetic material as the spacer layer between the hard magnetic layer 202 and the soft magnetic layer 204, the magnetoresistance device 200 may be configured as a giant magnetoresistive (GMR) device. The spacer layer of a conductive and non-magnetic material may have a thickness of between about 1 nm and about 20 nm, e.g. between about 1 nm and about 10 nm, between about 1 nm and about 5 nm, between about 5 nm and about 20 nm, between about 5 nm and about 10 nm, or between about 1.5 nm and about 5 nm.

In the context of various embodiments, the spacer layer may include a non-conductive and non-magnetic material including but not limited to magnesium oxide (MgO), titanium oxide (TiOₓ) or aluminium oxide (AlOₓ). By arranging a non-conductive and non-magnetic material as the spacer layer between the hard magnetic layer 202 and the soft magnetic layer 204, the magnetoresistance device 200 may be configured as a tunnel magnetoresistive (TMR) device. The spacer layer of a non-conductive and non-magnetic material may have a thickness of between about 0.4 nm and about 3.0 nm, e.g. between about 0.4 nm and about 2.0 nm, between about 0.4 nm and about 1.5 nm, between about 0.4 nm and about 0.8 nm, between about 0.8 nm and about 3.0 nm, between about 0.8 nm and about 2.0 nm, between about 0.6 nm and about 1.2 nm, between about 1.0 nm and about 3.0 nm, between about 1.0 nm and about 2.0 nm, or between about 2.0 nm and about 3.0 nm.

In the context of various embodiments, a spacer layer may also be referred to as a separating layer.

In various embodiments, the magnetoresistance device 200 may further include a first spin-polarizing layer disposed between the hard magnetic layer 202 and the spacer layer. The first spin-polarizing layer may include a material including but not limited to any one of or a combination of cobalt (Co), iron (Fe), nickel (Ni) or an alloy including at least one of cobalt (Co), iron (Fe) or nickel (Ni). In various embodiments, the first spin-polarizing layer may further include an additive or dopant including but not limited to boron (B), oxygen (O), nitrogen (N) or terbium (Tb). The first spin-polarizing layer may help in reducing the writing current of the hard magnetic layer 202. The first spin-polarizing layer may have a magnetization orientation in a direction substantially parallel or anti-parallel to the magnetization orientation of the hard magnetic layer 202.

In various embodiments, the magnetoresistance device 200 may further include a second spin-polarizing layer disposed between the soft magnetic layer 204 and the spacer layer. The second spin-polarizing layer may include a material including but not limited to any one of or a combination of cobalt (Co), iron (Fe), nickel (Ni) or an alloy including at least one of cobalt (Co), iron (Fe) or nickel (Ni). In various embodiments, the second spin-polarizing layer may further include an additive or dopant including but not limited to boron (B), oxygen (O), nitrogen (N) or terbium (Tb). The second spin-polarizing layer may help in reducing the writing current of the soft magnetic layer 204. The second spin-polarizing layer may have a magnetization orientation in a direction substantially parallel or anti-parallel to the magnetization orientation of the soft magnetic layer 204.

In various embodiments, the hard magnetic layer 202 and the soft magnetic layer 204 may be respectively configured such that their respective magnetic easy axis or magnetization orientation is oriented in a direction substantially perpendicular (i.e. perpendicular anisotropy) to a plane defined by an interface between the hard magnetic layer 202 and the soft magnetic layer 204.

In various embodiments, the hard magnetic layer 202 and the soft magnetic layer 204 may be respectively configured such that their respective magnetic easy axis or magnetization orientation is oriented in a direction substantially parallel (i.e. parallel anisotropy) to a plane defined by an interface between the hard magnetic layer 202 and the soft magnetic layer 204. Therefore, the magnetoresistance device 200 may be an in-plane magnetoresistance device.

In various embodiments, the hard magnetic layer 202 and the soft magnetic layer 204 may be respectively configured such that their respective magnetic easy axis or magnetization orientation is oriented in a direction at an angle to a plane defined by an interface between the hard magnetic layer 202 and the soft magnetic layer 204. Therefore, the respective magnetization orientations of the hard magnetic layer 202 and the soft magnetic layer 204 may be tilted to such a plane.

In the context of various embodiments, the term “easy axis” as applied to magnetism may mean an energetically favorable direction of spontaneous magnetization as a result of magnetic anisotropy. The magnetization orientation may be either of two opposite directions along the easy axis.

In various embodiments, the magnetoresistance device 200 may further include a second soft magnetic layer. The second soft magnetic layer may have a damping factor lower than each of the hard magnetic layer 202 and the soft magnetic layer 204. The second soft magnetic layer may have similar materials and/or arrangement and/or thickness as that of the soft magnetic layer 204.

The second soft magnetic layer may be disposed over the hard magnetic layer 202 and the soft magnetic layer 204, for example on top of the arrangement of the hard magnetic layer 202 and the soft magnetic layer 204, or the hard magnetic layer 202 and the soft magnetic layer 204 may be disposed over the second soft magnetic layer, for example the second soft magnetic layer may be arranged beneath the arrangement of the hard magnetic layer 202 and the soft magnetic layer 204.

The second soft magnetic layer may be configured such that its magnetization orientation is oriented in a direction substantially perpendicular or substantially parallel or at an angle to a plane defined by an interface between the second soft magnetic layer and either one of the hard magnetic layer 202 or the soft magnetic layer 204. The magnetization orientation of the second soft magnetic layer may be oriented in a direction that is parallel in a same direction or anti-parallel in an opposite direction to the magnetization orientations of the hard magnetic layer 202 and/or the soft magnetic layer 204.

In various embodiments, the magnetoresistance device 200 may further include a seed layer structure, wherein the hard magnetic layer 202 and the soft magnetic layer 204 may be disposed over the seed layer structure. The seed layer structure may facilitate the formation or growth of the hard magnetic layer 202 and/or the soft magnetic layer 204 and/or the second soft magnetic layer, for example so as to achieve suitable crystallographic and magnetic properties for the hard magnetic layer 202 and/or the soft magnetic layer 204 and/or the second soft magnetic layer. The seed layer structure may include one or more layers including a material including but not limited to any one of or a combination of tantalum (Ta), palladium (Pd), platinum (Pt), ruthenium (Ru), chromium (Cr), nickel (Ni), tungsten (W), aluminium (Al), molybdenum (Mo), iron (Fe), titanium (Ti), silver (Ag), or gold (Au).

In various embodiments, the magnetoresistance device 200 may further include a cap layer structure disposed over the hard magnetic layer 202 and the soft magnetic layer 204. The cap layer structure may include one or more layers including a material including but not limited to any one of or a combination of tantalum (Ta), palladium (Pd), platinum (Pt), ruthenium (Ru), chromium (Cr), nickel (Ni), tungsten (W), aluminium (Al), molybdenum (Mo), titanium (Ti), silver (Ag), gold (Au), carbon (C), nitrogen (N) or hydrogen (H).

In the context of various embodiments, the cap layer structure and the seed layer structure may be configured or used as electrodes (e.g. top and bottom electrodes) or separate metal electrodes may be formed or provided on the cap layer structure and the seed layer structure.

In the context of various embodiments, any one of or each of the first layer 206 and the second layer 208 of the soft magnetic layer 204 may be a single layer or may have a bilayer structure or a multilayer structure of a plurality of the bilayer structures (e.g. a number of repeating bilayer structures). The single layer may mean a layer which, by itself, has the desired properties, while the bilayer structure or the multilayer structure may mean a structure which, as a combination, has the desired properties.

In the context of various embodiments, the first layer 206 (e.g. denoted as ‘X’) and the second layer 208 (e.g. denoted as ‘Y’) may be arranged in any order as (X/Y), (Y/X), (X/Y/X/Y/X/Y) or (Y/X/Y/X), for example (X/Y)ₙ or (Y/X)ₙ, where n≧1, e.g. n=1, 2, 3, 4, 5, or any higher number.

In the context of various embodiments, the terms “hard layer”, “hard magnetic layer” or “ferromagnetic hard layer” may mean a layer having a hard ferromagnetic material. The hard ferromagnetic material may be resistant to magnetization and demagnetization (i.e. not easily magnetized and demagnetized), and may have a high hysteresis loss and a high coercivity. The magnetization orientation of the hard ferromagnetic material may be varied, depending on the degree or amount of the magnetization reversal field (or current). In the context of various embodiments, the hard magnetic layer may act as a reference layer.

In the context of various embodiments, the terms “soft layer”, “semi soft magnetic layer” “soft magnetic layer” or “ferromagnetic soft layer” may mean a layer having a soft ferromagnetic material. The soft ferromagnetic material may be receptive to magnetization and demagnetization (i.e. easily magnetized and demagnetized), and may have a smaller hysteresis loss and a lower coercivity, in comparison to the hard magnetic layer. The magnetization orientation of the soft magnetic material may be varied, depending on the degree or amount of the magnetization reversal field (or current), which may be less than that required for a hard magnetic layer. In the context of various embodiments, a soft magnetic layer may also be referred to as a free magnetic layer. In the context of various embodiments, the soft magnetic layer may act as a storage layer.

In the context of various embodiments, the magnetization orientation of a soft magnetic layer may be in one of two directions. The soft magnetic layer may be in a parallel state (P) or an anti-parallel state (AP) with respect to a hard magnetic layer. In the parallel state, the magnetization orientation of the soft magnetic layer is parallel to the magnetization orientation of the hard magnetic layer, such that the two magnetization orientations are in the same direction. In the anti-parallel state, the magnetization orientation of the soft magnetic layer is anti-parallel to the magnetization orientation of the hard magnetic layer, such that the two magnetization orientations are in opposite directions.

In the context of various embodiments, the magnetization orientation of the hard magnetic layer, the soft magnetic layer and the second soft magnetic layer may be in several possible directions, in order to represent various states such as “1” and “0” or multilevel states such as “00” “01” “10” and “11”.

In the context of various embodiments, the terms “first” and “second” with respect to a feature (e.g. first layer 206 and second layer 208 of the soft magnetic layer 204) may refer to separate but similar features. The terms may be interchangeable, for example depending on the arrangement of the magnetoresistance device. For example, where the first layer 206 and second layer 208 are arranged one above the other, the bottom layer may be termed as “first layer” while the top layer may be termed as “second layer”, or vice versa.

In the context of various embodiments, the magnetoresistance device 200 may be a magnetoresistive device, where the resistance state of the magnetoresistance device 200 may change as a result of a change in its resistivity.

In the context of various embodiments, the magnetoresistance device 200 may be or may form part of a memory device, e.g. a magnetoresistive random access memory (MRAM).

In the context of various embodiments, the term “damping factor” may mean the anisotropy constant of a magnetic layer. The damping factor is a material parameter that may control the magnetization reversal current and speed. Therefore, the damping factor of a magnetic layer may affect the switching of its magnetization direction or orientation, in that the writing current for switching the magnetization may increase, e.g. proportionally, with the increase in damping factor. The damping factor of a magnetic layer may also affect the writing speed, which may increase, e.g. proportionally, with the increase in damping factor. Therefore, a higher damping factor material may correspond to a higher writing current and a higher writing speed. Correspondingly, a lower damping factor material may correspond to a lower writing current and a lower writing speed.

In the context of various embodiments, the term “adjacent” as applied to two layers may include an arrangement where the two layers are in contact with each other or an arrangement where the two layers are separated by an intermediate layer, e.g. a spacer layer.

Various embodiments may also provide a memory device. The memory device may include a magnetoresistance device of various embodiments as described herein.

Various embodiments may also provide a sensor. The sensor may include a magnetoresistance device of various embodiments as described herein.

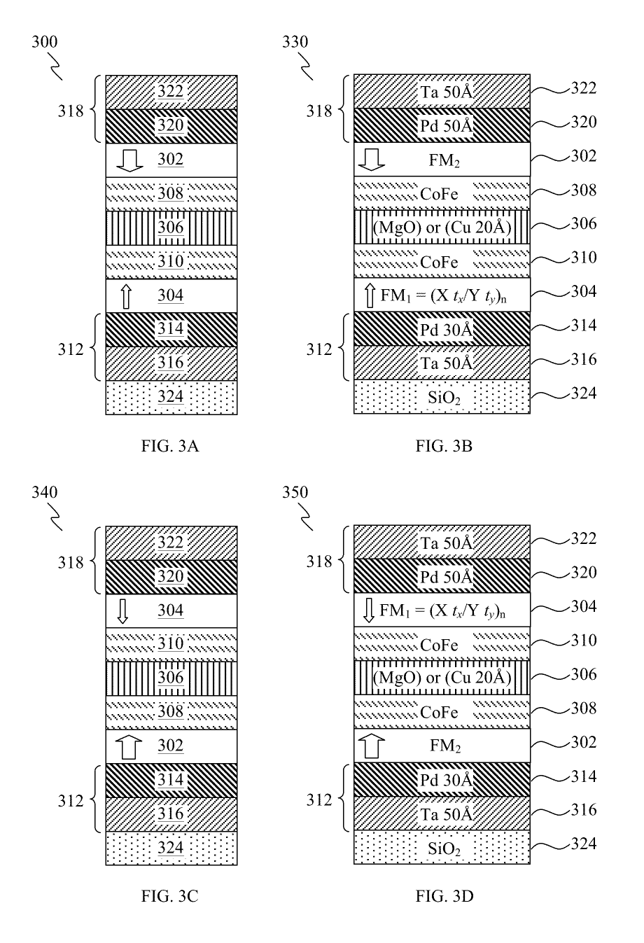

FIG. 3A shows a schematic view of a magnetoresistance device 300, according to various embodiments. The magnetoresistance device 300 may be a giant magnetoresistive (GMR) device or a tunneling magnetoresistive (TMR) device, e.g. a spin transfer torque magnetic random access memory (STT-MRAM). The magnetoresistance device 300 may have a perpendicular anisotropy. The magnetoresistive device 300 has a stack structure, having for example a plurality of ferromagnetic layers. The magnetoresistive device 300 may have a single spin-valve structure (S-SV) or a single magnetic tunnel junction (S-MTJ) structure.

The magnetoresistance device 300 includes two ferromagnetic layers (a hard magnetic layer 302 and a soft magnetic layer 304 arranged one over the other) with different magnetization reversal currents or magnetization reversal fields. Each of the hard magnetic layer 302 and the soft magnetic layer 304 may have a variable magnetization orientation, i.e. the magnetization orientation is changeable or switchable between different orientations or states in response to a current or a voltage applied across the magnetoresistance device 300. The hard magnetic layer 302 and the soft magnetic layer 304 may be or may form part of a magnetic junction of the magnetoresistance device 300.

The soft magnetic layer 304 may include two or more layers. In the embodiment as shown in FIG. 3B, the soft magnetic layer 304 includes two layers, being layer X and layer Y. The layer X in the soft magnetic layer 304 may be of a lower damping factor as compared to layer Y in the soft magnetic layer 304. The materials for layers X and Y and/or their relative thicknesses may be chosen to achieve switching at lower currents and at higher speeds. Such a stack arrangement for the soft magnetic layer 304 may have an overall damping factor lower than that of the hard magnetic layer 302. As a result of the lower damping factor, the magnetization of the soft magnetic layer 304 may be reversed or switched by a low reversal current, or at least lower than the reversal current required for switching the magnetization of the hard magnetic layer 302.

The hard magnetic layer 302 and the soft magnetic layer 304 have their respective magnetic easy axis (e.g. magnetization orientation or direction) aligned in a perpendicular direction (i.e. perpendicular anisotropy), for example in a direction at least substantially perpendicular to a plane defined by an interface, for example an interface between the hard magnetic layer 302 and the soft magnetic layer 304. As shown in FIG. 3A, the arrow shown within the hard magnetic layer 302 illustrates the direction of magnetization orientation of the hard magnetic layer 302. While the arrow is shown pointing in a downward direction, it should be appreciated that the arrow may be illustrated as pointing in an upward direction, such that a magnetization orientation in the opposite direction to that of the embodiment of FIG. 3A may be provided for the hard magnetic layer 302.

The magnetization orientation or direction of the soft magnetic layer 304 may be oriented parallel to and in the same direction (parallel state) as the magnetization orientation of the hard magnetic layer 302, or oriented parallel to and in the opposite direction (anti-parallel state) as the magnetization orientation of the hard magnetic layer 302. The arrow shown within the soft magnetic layer 304 illustrates the direction of the magnetization orientation of the soft magnetic layer 304. While the arrow is shown pointing in an upward direction, it should be appreciated that the arrow may be illustrated as pointing in a downward direction, such that a magnetization orientation in the opposite direction to that of the embodiment of FIG. 3A may be provided for the soft magnetic layer 304. The relative sizes of the arrows within the hard magnetic layer 302 and the soft magnetic layer 304 show the relative degree of “hardness” of the magnetic layer, where a larger sized arrow represents a higher degree of “hardness”.

It should be appreciated that in some embodiments, the hard magnetic layer 302 and the soft magnetic layer 304 may have their respective magnetic easy axis (e.g. magnetization orientation or direction) aligned in a parallel direction (i.e. parallel anisotropy), for example in a direction at least substantially parallel to a plane defined by an interface, for example an interface between the hard magnetic layer 302 and the soft magnetic layer 304, or may be aligned at an angle to the interface between the hard magnetic layer 302 and the soft magnetic layer 304.

The hard magnetic layer 302 may have a thickness in a range of between about 0.3 nm and about 10 nm, for example between about 0.3 nm and about 8 nm, between about 0.3 nm and about 5 nm, between about 0.3 nm and about 2 nm, between about 0.3 nm and about 1 nm, between about 1 nm and about 10 nm, between about 1 nm and about 8 nm, between about 1 nm and about 4 nm, between about 2 nm and about 10 nm, or between about 4 nm and about 6 nm.

The soft magnetic layer 304 may have a thickness in a range of between about 0.3 nm and about 10 nm, for example between about 0.3 nm and about 8 nm, between about 0.3 nm and about 5 nm, between about 0.3 nm and about 2 nm, between about 0.3 nm and about 1 nm, between about 1 nm and about 10 nm, between about 1 nm and about 8 nm, between about 1 nm and about 4 nm, between about 2 nm and about 10 nm, or between about 4 nm and about 6 nm.

The magnetoresistance device 300 further includes a spacer layer 306 arranged in between the hard magnetic layer 302 and the soft magnetic layer 304. The spacer layer 306 may be of a non-conductive and non-magnetic material, including but not limited to one or more of magnesium oxide (MgO), aluminium oxide (AlOₓ), or titanium oxide (TiOₓ) to achieve a higher tunneling magnetoresistive effect. The magnetoresistance device 300 may therefore be configured as a tunneling magnetoresistive (TMR) device.

The spacer layer 306 may instead be of a conductive and non-magnetic material (e.g. a conductor), including but not limited to one or more of copper (Cu), silver (Ag), gold (Au), tantalum (Ta), chromium (Cr), palladium (Pd), platinum (Pt) or ruthenium (Ru). The magnetoresistance device 300 may therefore be configured as a giant magnetoresistive (GMR) device.

The spacer layer 306 may have a thickness between about 0.4 nm and about 5 nm, e.g. between about 1 nm and about 5 nm, between about 0.4 nm and about 2 nm, between about 1 nm and about 3 nm, between about 2 nm and about 5 nm, between about 1 nm and about 4 nm, between about 1.5 nm and about 5 nm, between about 0.4 nm and about 1 nm, between about 0.4 nm and about 1.5 nm, between about 0.4 nm and about 0.8 nm, between about 0.8 nm and about 2.0 nm, between about 0.8 nm and about 1.5 nm or between about 0.6 nm and about 1.2 nm.

The magnetoresistance device 300 further includes a spin-polarizing layer 308 adjacent to the hard magnetic layer 302 and the spacer layer 306. The magnetoresistance device 300 further includes a spin-polarizing layer 310 adjacent to the soft magnetic layer 304 and the spacer layer 306. Any one or each of the spin-polarizing layers 308, 310 may include any one of or an alloy of Co, Fe, Ni, and may also include one or more additives (or dopants) including but not limited to boron (B), oxygen (O) and terbium (Tb). The spin-polarizing layers 308, 310 may help, for example, to increase the interface quality at the tunnel barrier or the spacer layer 306, as well as enhancing the coherent tunneling which may lead to a higher TMR signal.

Each of the spin-polarizing layers 308, 310 may have a thickness in a range of between about 0.2 nm and about 2 nm, for example between about 0.2 nm and about 1.5 nm, between about 0.2 nm and about 1.0 nm, between about 0.2 nm and about 0.5 nm, between about 0.5 nm and about 2 nm, between about 0.5 nm and about 1 nm, or between about 1 nm and about 1.5 nm.

The magnetoresistance device 300 further includes a seed layer structure 312 arranged beneath the hard magnetic layer 302 and the soft magnetic layer 304. The seed layer structure 312 may have two layers 314, 316, for example two metal layers, arranged one over the layer. The metal layer 314 may have a thickness in a range of between about 1 nm and about 100 nm, for example between about 1 nm and about 50 nm, between about 1 nm and about 20 nm, between about 20 nm and about 100 nm or between about 30 nm and about 80 nm. The metal layer 316 may have a thickness in a range of between about 2 nm and about 20 nm, for example between about 2 nm and about 10 nm, between about 2 nm and about 5 nm, between about 5 nm and about 20 nm or between about 5 nm and about 10 nm.

In various embodiments, the seed layer structure 312 may be employed to enhance the desired crystallographic texture and magnetic anisotropy (e.g. perpendicular magnetic anisotropy). The seed layer structure 312 may include one or more layers including a material including but not limited to any one of or a combination of tantalum (Ta), palladium (Pd), platinum (Pt), ruthenium (Ru), chromium (Cr), nickel (Ni), tungsten (W), aluminium (Al), molybdenum (Mo), iron (Fe), titanium (Ti), silver (Ag), or gold (Au).

The magnetoresistance device 300 further includes a cap layer structure 318 arranged over the hard magnetic layer 302 and the soft magnetic layer 304. The cap layer structure 318 may have two layers 320, 322, for example two metal layers, arranged one over the layer. The metal layer 320 may have a thickness in a range of between about 0.1 nm and about 10 nm, for example between about 0.1 nm and about 5 nm, between about 0.1 nm and about 2 nm, between about 1 nm and about 10 nm or between about 3 nm and about 5 nm. However, in alternative embodiments, the metal layer 320 may be absent. The metal layer 322 may have a thickness in a range of between about 3 nm and about 100 nm, for example between about 3 nm and about 50 nm, between about 3 nm and about 20 nm, between about 20 nm and about 100 nm or between about 30 nm and about 80 nm.

In various embodiments, the cap layer structure 318 may include one or more layers including a material including but not limited to any one of or a combination of tantalum (Ta), palladium (Pd), platinum (Pt), ruthenium (Ru), chromium (Cr), nickel (Ni), tungsten (W), aluminium (Al), molybdenum (Mo), titanium (Ti), silver (Ag), gold (Au), carbon (C), nitrogen (N) or hydrogen (H).

In various embodiments, the magnetoresistance device 300 includes a substrate 324 on which the hard magnetic layer 302 and the soft magnetic layer 304 may be formed or disposed on.

FIG. 3B shows an embodiment of the magnetoresistance device 300 of FIG. 3A. The magnetoresistance device 330 of FIG. 3B includes a hard magnetic layer, FM₂, (also called a reference layer) 302 and a soft magnetic layer, FM₁, 304, arranged one over the other. The soft magnetic layer, FM₁, 304 (also called a free layer) has a layer structure or stack structure of (X tₓ/Y t_{y})ₙ where n≧1, e.g. 1, 2, 3, 4, 5 or any higher number.

The magnetoresistance device 330 further includes a magnesium oxide (MgO) spacer layer 306 of a thickness of between about 0.2 nm and about 3 nm or a copper (Cu) spacer layer 306 of a thickness of about 20 Å (angstrom). The magnetoresistance device 330 further includes copper-iron (CoFe) spin-polarizing layers 308, 310, each layer having a thickness of between about 0.2 nm and about 2 nm.

The magnetoresistance device 330 further includes a seed layer structure 312 having a palladium (Pd) layer 314 of a thickness of about 30 Å and a tantalum (Ta) layer 316 of a thickness of about 50 Å. The magnetoresistance device 330 further includes a cap layer structure 318 having a palladium (Pd) layer 320 of a thickness of about 50 Å and a tantalum (Ta) layer 322 of a thickness of about 50 Å. The magnetoresistance device 330 further includes a silicon oxide (SiO₂) substrate 324 on which the hard magnetic layer, FM₂, 302 and the soft magnetic layer, FM₁, 304 are formed or disposed on.

While FIGS. 3A and 3B show that the hard magnetic layer 302 is arranged over the soft magnetic layer 304 (i.e. the soft magnetic layer 304 is at the bottom, proximal to the substrate 324, and the hard magnetic layer 302 is at the top), the respective positions of the hard magnetic layer 302 and the soft magnetic layer 304 may be interchangeable such that the soft magnetic layer 304 is arranged over the hard magnetic layer 302 (i.e. the soft magnetic layer 304 is at the top and the hard magnetic layer 302 is at the bottom, proximal to the substrate 324), as shown in FIGS. 3C and 3D for magnetoresistance devices 340, 350 respectively. Features or layers of the magnetoresistance devices 340, 350 that are similarly present in the magnetoresistance devices 300, 330 may be as described in the context of the magnetoresistance devices 300, 330.

In the context of various embodiments, the soft magnetic layer, FM₁, 304 has a layer structure or stack structure of (X tₓ/Y t_{y})ₙ (n≧1) in order to achieve an optimized value of magnetization reversal current and/or magnetization reversal speed, where the layers X and Y are arranged alternately. Therefore, the soft magnetic layer, FM₁, 304 may have one or more bilayer structures of layer X and layer Y, where the bilayer structures may be arranged one above the other. The total number (n) of bilayer structures of layers X and Y may be chosen to achieve a suitable value of the thermal factor of (kᵤV/k_{B}T) (where kᵤ is the uniaxial anisotropy constant, k_{B} is the Boltzmann constant and T is temperature) to achieve the suitable thermal stability. The total number (n) may be between 1 and 12, for example between 1 and 8, between 1 and 5, or between 4 and 10, e.g. 2 (i.e. (X tₓ/Y t_{y})₂, (X tₓ/Y t_{y}/X tₓ/Y t_{y})), 4, 6, or 12. In addition or as an alternative, the total number (n) of bilayer structures may be chosen so as to achieve the desired properties for the magnetoresistance devices 300, 330, 340, 350, for example magnetic properties.

The layer X has a lower damping factor while the layer Y has a larger damping factor. The damping factor is a material parameter that controls the magnetization reversal current and speed. A material with a lower damping factor is chosen for layer X, so that the critical current needed to switch the magnetization may be lower. The layer Y is chosen to have a larger damping factor, in order to achieve the magnetization reversal at a faster speed.

The layer X may be a bilayer structure of cobalt-iron-boron/palladium (CoFeB/Pd) and the layer Y may be a bilayer structure of cobalt/palladium (Co/Pd). A thickness of the CoFeB layer as part of the superlattice structure (CoFeB/Pd) for layer X may be between about 0.2 nm and about 1 nm, e.g. between about 0.2 nm and about 0.8 nm, between about 0.2 nm and about 0.5 nm or between about 0.5 nm and about 1 nm. Such a thickness range of between about 0.2 nm and about 1 nm may provide a suitable magnetic anisotropy, e.g. perpendicular magnetic anisotropy.

A thickness of the Co layer as part of the superlattice structure (Co/Pd) of layer Y may be between about 0.2 nm and about 1 nm, e.g. between about 0.2 nm and about 0.8 nm, between about 0.2 nm and about 0.5 nm or between about 0.5 nm and about 1 nm. Such a thickness range of between about 0.2 nm and about 1 nm may provide a suitable magnetic anisotropy, e.g. perpendicular magnetic anisotropy.

It should be appreciated that layer X may include one or more layers of one or more materials of cobalt-iron-boron (CoFeB), cobalt (Co), iron (Fe), nickel (Ni) or an alloy of any of Co, Fe and Ni. It should be appreciated that layer Y may include one or more layers of one or more materials of iron-platinum (FePt), cobalt-platinum (CoPt), or an alloy of any of Co, Fe, Ni, Pt, and Pd.

In various embodiments, the layer X may be a single magnetic layer, where the thickness may be chosen in such a way that the volume V of the soft magnetic layer, FM₁, 304, as a whole, may meet a suitable value of the thermal factor of (kᵤV/k_{B}T) (where kᵤ is the uniaxial anisotropy constant, k_{B} is the Boltzmann constant and T is temperature) to achieve thermal stability. This similarly applies to embodiments where the layer Y is a single magnetic layer.

In the context of various embodiments, the parameter tₓ for the layer X of the soft magnetic layer, FM₁, 304 represents the thickness of the layer X while the parameter t_{y} for the layer Y of the soft magnetic layer, FM₁, 304 represents the thickness of the layer Y. Each of tₓ and t_{y} may be in the range of between about 0.3 nm and about 5 nm, for example between about 0.3 nm and about 3 nm, between about 0.3 nm and about 1 nm, between about 1 nm and about 5 nm, or between about 2 nm and about 4 nm. It should be appreciated that each of tₓ and t_{y} may be selected or optimized based on the materials for layers X and Y respectively or based on the materials for both layers X and Y.

In the context of various embodiments, the hard magnetic layer, FM₂, 302 may include an alloy of CoPt, multilayers of Co/Z where Z is Pt, Pd or an alloy of Pt and Pd. In addition, materials such as FePt, CoPt with a high anisotropy may also be used for the hard magnetic layer, FM₂, 302.

Various embodiments may further provide a magnetoresistance device with three ferromagnetic layers with three different magnetization reversal currents or magnetization reversal fields. One or more of the ferromagnetic layers may include two magnetic layers having materials with two damping factors. In other words, each magnetic layer has a damping factor different from that of the other magnetic layer.

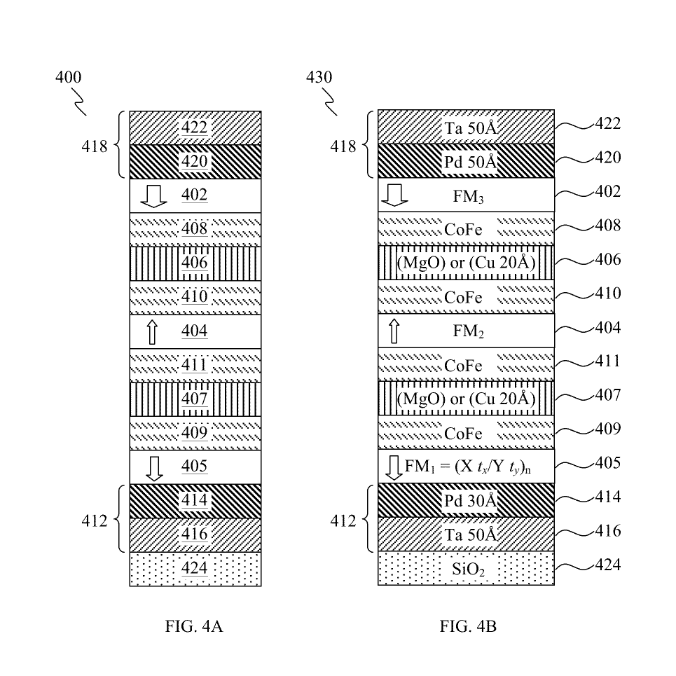

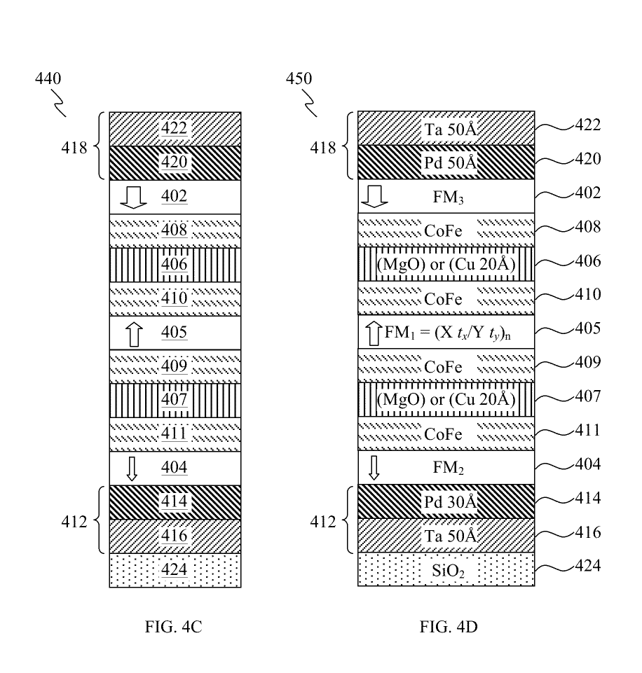

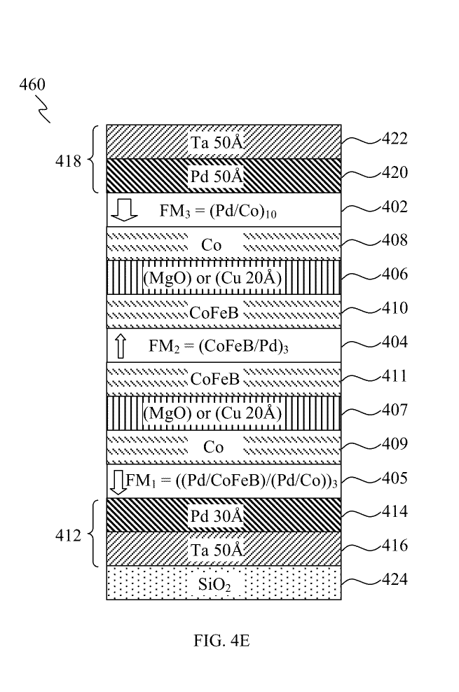

FIG. 4A shows a schematic view of a magnetoresistance device 400, according to various embodiments. The magnetoresistance device 400 may be a giant magnetoresistive (GMR) device or a tunneling magnetoresistive (TMR) device, e.g. a spin transfer torque magnetic random access memory (STT-MRAM). The magnetoresistance device 400 may have a perpendicular anisotropy. The magnetoresistive device 400 has a stack structure, having for example a plurality of ferromagnetic layers. The magnetoresistive device 400 may have a dual spin-valve (D-SV) or a dual magnetic tunnel junction (D-MTJ) structure.

The magnetoresistance device 400 includes three ferromagnetic layers in the form of a hard magnetic layer 402, a soft magnetic layer 404 and a semi soft magnetic layer (or another soft magnetic layer) 405, arranged one over the other. The hard magnetic layer 402, the soft magnetic layer 404 and the semi soft magnetic 405 may have different magnetization reversal currents or magnetization reversal fields.

Each of the hard magnetic layer 402, the soft magnetic layer 404 and the semi soft magnetic 405 may have a variable magnetization orientation, i.e. the magnetization orientation is changeable or switchable between different orientations or states in response to a current or a voltage applied across the magnetoresistance device 400. The hard magnetic layer 402, the soft magnetic layer 404 and the semi soft magnetic 405 may be or may form part of a magnetic junction of the magnetoresistance device 400.

The hard magnetic layer 402, the soft magnetic layer 404 and the semi soft magnetic 405, have their respective magnetic easy axis (e.g. magnetization orientation or direction) aligned in a perpendicular direction (i.e. perpendicular anisotropy), for example in a direction at least substantially perpendicular to a plane defined by an interface, for example an interface between the hard magnetic layer 402 and the soft magnetic layer 404, or an interface between the soft magnetic layer 404 and the semi soft magnetic 405. As shown in FIG. 4A, the arrow shown within the hard magnetic layer 402 illustrates the direction of magnetization orientation of the hard magnetic layer 402. While the arrow is shown pointing in a downward direction, it should be appreciated that the arrow may be illustrated as pointing in an upward direction, such that a magnetization orientation in the opposite direction to that of the embodiment of FIG. 4A may be provided for the hard magnetic layer 402.

The magnetization orientation or direction of the soft magnetic layer 404 may be oriented parallel to and in the same direction (parallel state) as the magnetization orientation of the hard magnetic layer 402, or oriented parallel to and in the opposite direction (anti-parallel state) as the magnetization orientation of the hard magnetic layer 402. The arrow shown within the soft magnetic layer 404 illustrates the direction of the magnetization orientation of the soft magnetic layer 404. While the arrow is shown pointing in an upward direction, it should be appreciated that the arrow may be illustrated as pointing in a downward direction, such that a magnetization orientation in the opposite direction to that of the embodiment of FIG. 4A may be provided for the soft magnetic layer 404.

The magnetization orientation or direction of the semi soft magnetic 405 may be oriented parallel to and in the same direction (parallel state) as the magnetization orientation of the hard magnetic layer 402, or oriented parallel to and in the opposite direction (anti-parallel state) as the magnetization orientation of the hard magnetic layer 402. The arrow shown within the semi soft magnetic 405 illustrates the direction of the magnetization orientation of the semi soft magnetic 405. While the arrow is shown pointing in a downward direction, it should be appreciated that the arrow may be illustrated as pointing in an upward direction, such that a magnetization orientation in the opposite direction to that of the embodiment of FIG. 4A may be provided for the semi soft magnetic 405.

The relative sizes of the arrows within the hard magnetic layer 402, the soft magnetic layer 404 and the semi soft magnetic layer 405 show the relative degree of “hardness” of the magnetic layer, where a larger sized arrow represents a higher degree of “hardness”.

It should be appreciated that in some embodiments, the hard magnetic layer 402, the soft magnetic layer 404 and the semi soft magnetic 405 may have their respective magnetic easy axis (e.g. magnetization orientation or direction) aligned in a parallel direction (i.e. parallel anisotropy), for example in a direction at least substantially parallel to a plane defined by an interface, for example an interface between the hard magnetic layer 402 and the soft magnetic layer 404, or may be aligned at an angle to the interface between the hard magnetic layer 402 and the soft magnetic layer 404.

It should be appreciated that the hard magnetic layer 402 may be as described in the context of the hard magnetic layer 302 of the magnetoresistance device 300. It should be appreciated that the soft magnetic layer 404 may be as described in the context of the soft magnetic layer 304 of the magnetoresistance device 300. It should be appreciated that the semi soft magnetic layer 405 may be as described in the context of the soft magnetic layer 304 of the magnetoresistance device 300.

The soft magnetic layer 404 may have the lowest overall damping factor as compared to that of the hard magnetic layer 402 and the semi soft magnetic layer 405. As a result of the lowest damping factor, the magnetization of the soft magnetic layer 404 may be reversed or switched by a low reversal current, or at least lower than the reversal current required for switching the respective magnetization of each of the hard magnetic layer 402 or the semi soft magnetic layer 405.

The magnetoresistance device 400 further includes a spacer layer 406 arranged in between the hard magnetic layer 402 and the soft magnetic layer 404. The magnetoresistance device 400 further includes a spacer layer 407 arranged in between the soft magnetic layer 404 and the semi soft magnetic layer 405. Each of the spacer layers 406, 407 may be as described in the context of the spacer layer 306 of the magnetoresistance device 300.

The magnetoresistance device 400 further includes a spin-polarizing layer 408 adjacent to the hard magnetic layer 402 and the spacer layer 406. The magnetoresistance device 400 further includes a spin-polarizing layer 410 adjacent to the soft magnetic layer 404 and the spacer layer 406. The magnetoresistance device 400 further includes a spin-polarizing layer 409 adjacent to the semi soft magnetic layer 405 and the spacer layer 407. The magnetoresistance device 400 further includes a spin-polarizing layer 411 adjacent to the soft magnetic layer 404 and the spacer layer 407. Each of the spin-polarizing layers 408, 409, 410, 411 may be as described in the context of any one of the spin-polarizing layers 308, 310 of the magnetoresistance device 300.

The magnetoresistance device 400 further includes a seed layer structure 412 arranged beneath the hard magnetic layer 402, the soft magnetic layer 404 and the semi soft magnetic layer 405. The seed layer structure 412 may have two layers 414, 416, for example two metal layers, arranged one over the layer. The layer 414 may be as described in the context of the layer 314 of the magnetoresistance device 300, while the layer 416 may be as described in the context of the layer 316 of the magnetoresistance device 300.

The magnetoresistance device 400 further includes a cap layer structure 418 arranged over the hard magnetic layer 402, the soft magnetic layer 404 and the semi soft magnetic layer 405. The cap layer structure 418 may have two layers 420, 422, for example two metal layers, arranged one over the layer. The layer 420 may be as described in the context of the layer 320 of the magnetoresistance device 300, while the layer 422 may be as described in the context of the layer 322 of the magnetoresistance device 300.

In various embodiments, the magnetoresistance device 400 includes a substrate 424 on which the hard magnetic layer 402, the soft magnetic layer 404 and the semi soft magnetic layer 405 may be formed or disposed on. The substrate 424 may be as described in the context of the substrate 324 of the magnetoresistance device 300.

FIG. 4B shows an embodiment of the magnetoresistance device 400 of FIG. 4A. The magnetoresistance device 430 of FIG. 4B includes a hard magnetic layer, FM₂, (also called a reference layer) 402, a soft magnetic layer, FM₂, 404, and a semi soft layer, FM₁, 405, arranged one over the other. The semi soft magnetic layer, FM₁, 405 has a layer structure or stack structure of (X tₓ/Y t_{y})ₙ where n≧1, e.g. 1, 2, 3, 4, 5 or any higher number.

The magnetoresistance device 430 further includes a magnesium oxide (MgO) spacer layer 406 of a thickness of between about 0.2 nm and about 3 nm or a copper (Cu) spacer layer 306 of a thickness of about 20 Å (angstrom). The magnetoresistance device 430 further includes a magnesium oxide (MgO) spacer layer 407 or a copper (Cu) spacer layer 307 of a thickness of about 20 Å (angstrom). The magnetoresistance device 430 further includes copper-iron (CoFe) spin-polarizing layers 408, 409, 410, 411, each layer having a thickness of between about 0.2 nm and about 2 nm.

The magnetoresistance device 430 further includes a seed layer structure 412 having a palladium (Pd) layer 414 of a thickness of about 30 Å and a tantalum (Ta) layer 416 of a thickness of about 50 Å. The magnetoresistance device 430 further includes a cap layer structure 418 having a palladium (Pd) layer 420 of a thickness of about 50 Å and a tantalum (Ta) layer 422 of a thickness of about 50 Å. The magnetoresistance device 430 further includes a silicon oxide (SiO₂) substrate 424 on which the hard magnetic layer, FM₃, 402, the soft magnetic layer, FM₂, 404, and the semi soft magnetic layer, FM₁, 405, are formed or disposed on.

While FIGS. 4A and 4B show that the hard magnetic layer 402 is arranged over the soft magnetic layer 404 and the semi soft magnetic layer 405, and that the soft magnetic layer 404 is arranged over the semi soft magnetic layer 405 (i.e. the semi soft magnetic layer 405 is at the bottom, proximal to the substrate 424, the hard magnetic layer 402 is at the top, and the soft magnetic layer 404 arranged in between), the respective positions of the soft magnetic layer 404 and the semi soft magnetic layer 405 may be interchangeable such that the semi soft magnetic layer 405 is arranged over the soft magnetic layer 404 (i.e. the hard magnetic layer 402 is at the top, the soft magnetic layer 404 is at the bottom, proximal to the substrate 424, and the semi soft magnetic layer 405 arranged in between), as shown in FIGS. 4C and 4D for magnetoresistance devices 440, 450 respectively. Features or layers of the magnetoresistance devices 440, 450 that are similarly present in the magnetoresistance devices 400, 430 may be as described in the context of the magnetoresistance devices 400, 430.

In further embodiments, the hard magnetic layer 402 may be arranged at the bottom, proximal to the substrate 424, with the semi soft magnetic layer 405 arranged at the top and the soft magnetic layer 404 arranged in between, or with the soft magnetic layer 404 arranged at the top and the semi soft magnetic layer 405 arranged in between.

In the context of various embodiments, the semi soft magnetic layer, FM₁, 405 has a layer structure or stack structure of (X tₓ/Y t_{y})ₙ (n≧1) in order to achieve an optimized value of magnetization reversal current and/or magnetization reversal speed, where the layers X and Y are arranged alternately. Therefore, the semi soft magnetic layer, FM₁, 405 may have one or more bilayer structures of layer X and layer Y, where the bilayer structures may be arranged one above the other. The total number (n) of bilayer structures of layers X and Y may be chosen to achieve a suitable value of the thermal factor of (kᵤV/k_{B}T) (where kᵤ is the uniaxial anisotropy constant, k_{B} is the Boltzmann constant and T is temperature) to achieve the suitable thermal stability. The total number (n) may be between 1 and 12, for example between 1 and 8, between 1 and 5, or between 4 and 10, e.g. 2 (i.e. (X tₓ/Y t_{y})₂, (X tₓ/Y t_{y}/X tₓ/Y t_{y})), 4, 6, or 12. In addition or as an alternative, the total number (n) of bilayer structures may be chosen so as to achieve the desired properties for the magnetoresistance devices 400, 430, 440, 450, for example magnetic properties.

The layer X has a lower damping factor while the layer Y has a larger damping factor. The damping factor is a material parameter that controls the magnetization reversal current and speed. A material with a lower damping factor is chosen for layer X, so that the critical current needed to switch the magnetization may be lower. The layer Y is chosen to have a larger damping factor, in order to achieve the magnetization reversal at a faster speed.

In the context of various embodiments, the parameter tₓ for the layer X of the semi soft magnetic layer, FM₁, 405 represents the thickness of the layer X while the parameter t_{y} for the layer Y of the semi soft magnetic layer, FM₁, 405 represents the thickness of the layer Y.

The layers X and Y may be similar to that as described respectively in the context of the magnetoresistance devices 300, 330, 340, 350.

The hard magnetic layer, FM₃, 402 may be similar to that as described in the context of the hard magnetic layer 302 of the magnetoresistance devices 300, 330, 340, 350. In one embodiment, the hard magnetic layer, FM₃, 402 may include a stack layer or structure of 10 bilayer structures of cobalt (Co) and palladium (Pd), e.g. (Co/Pd)₁₀ which has a much higher coercivity/magnetization reversal current as compared to that for the soft magnetic layer, FM₂, 404, and the semi soft magnetic layer, FM₁, 405.

FIG. 4E shows an embodiment of the magnetoresistance device of FIG. 4A. The magnetoresistance device 460 of FIG. 4E is similar to the magnetoresistance device 430 of FIG. 4B, except that the spin-polarizing layer 408 includes cobalt (Co), the spin-polarizing layer 410 includes cobalt-iron-boron (CoFeB), the spin-polarizing layer 409 includes cobalt (Co) and the spin-polarizing layer 411 includes cobalt-iron-boron (CoFeB).

The hard magnetic layer, FM₂, 402 includes a stack layer or structure of 10 bilayer structures of cobalt (Co) and palladium (Pd), e.g. (Co/Pd)₁₀. The soft magnetic layer, FM₂, 404 includes a stack layer or structure of 3 bilayer structures of cobalt-iron-boron (CoFeB) and palladium (Pd), e.g. (CoFeB/Pd)₃. The semi soft magnetic layer, FM₁, 405 includes a stack layer or structure of 3 bilayer structures of layers X and Y, where layer X includes a bilayer structure of palladium (Pd) and cobalt-iron-boron (CoFeB), e.g. (Pd/CoFeB) and layer Y includes a bilayer structure of palladium (Pd) and cobalt (Co), e.g. (Pd/Co). In other words, the semi soft magnetic layer, FM₁, 405 has a stack structure of ((Pd/Co)/(Pd/CoFeB))₃.

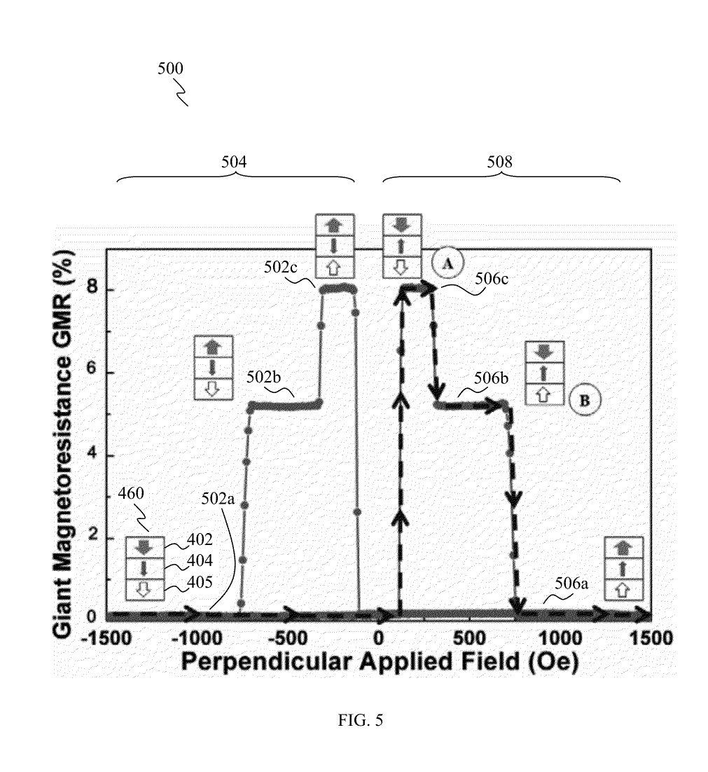

FIG. 5 shows a plot 500 of magnetization reversal characteristics of the embodiment of FIG. 4E. As shown in FIG. 5, three magnetization states 502a, 502b, 502c, and 506a, 506b, 506c, may be noticed on each side of the respective loop 504, 508, corresponding to the reversal of the hard magnetic layer 402, the soft magnetic layer 404 and the semi soft magnetic layer 405. As examples, the magnetoresistance device 460, with the corresponding magnetization orientations of the respective ferromagnetic layers as represented with the circle with the letter “A”, represents the magnetization state 506c while the magnetoresistance device 460, with the corresponding magnetization orientations of the respective ferromagnetic layers as represented with the circle with the letter “B”, represents the magnetization state 506b.

The magnetoresistance device 460 may achieve four resistance levels or states at remnant state and hence may be used for multi-level or multi-bit storage. The four resistance states may correspond, for example to (1) where the respective magnetization directions of the soft magnetic layer 404 and the semi soft magnetic layer 405 are parallel to the magnetization direction of the hard magnetic layer 402 (lowest resistance state), (2) where the respective magnetization directions of the soft magnetic layer 404 and the semi soft magnetic layer 405 are anti-parallel to the magnetization direction of the hard magnetic layer 402 (highest resistance state), (3) where the magnetization direction of the soft magnetic layer 404 is parallel to, while the magnetization direction of the semi soft magnetic layer 405 is anti-parallel to the magnetization direction of the hard magnetic layer 402, and (4) where the magnetization direction of the soft magnetic layer 404 is anti-parallel to, while the magnetization direction of the semi soft magnetic layer 405 is parallel to the magnetization direction of the hard magnetic layer 402.

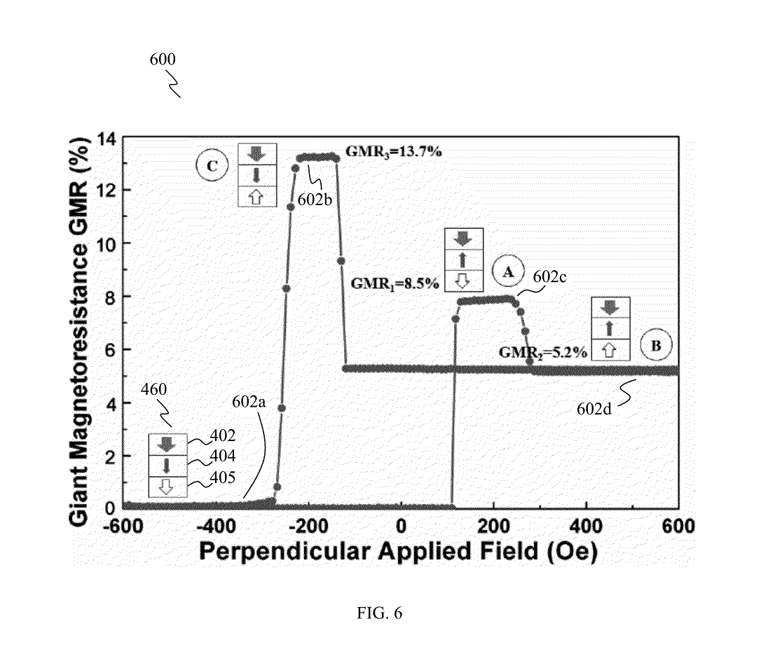

FIG. 6 shows a plot 600 of minor loops of the embodiment of FIG. 4E. As the magnetoresistance device 460 has two soft magnetic layers and one hard magnetic layer, there may be four magnetic states or magnetization reversal states.

The reversal at the highest perpendicular applied fields, at approximately +300 Oe and −300 Oe, is attributed to the hard magnetic layer 402, which is of (Co/Pd)₁₀. The reversal at the medium perpendicular applied fields, at approximately +100 Oe and −100 Oe, is attributed to the semi soft magnetic layer, FM₁, 405 having a stack structure with two layers having two different damping factors, (X/Y)₃, where layer X is CoFeB/Pd and layer Y is Co/Pd. The stack structure having X/Y layers may help to tune the magnetization reversal field. As shown in FIG. 6, the magnetization orientation of the hard magnetic layer 402 does not change, while the magnetization orientations of the soft magnetic layer 404 and the semi soft magnetic layer 405 change, within the magnetic field range of between +600 Oe and −600 Oe.

As examples, the magnetoresistance device 460, with the corresponding magnetization orientations of the respective ferromagnetic layers as represented with the circle with the letter “A”, represents the magnetization state 602c, the magnetoresistance device 460, with the corresponding magnetization orientations of the respective ferromagnetic layers as represented with the circle with the letter “B”, represents the magnetization state 602d, while the magnetoresistance device 460, with the corresponding magnetization orientations of the respective ferromagnetic layers as represented with the circle with the letter “C”, represents the magnetization state 602b.

While the figures and the corresponding descriptions illustrate particular arrangements of the hard magnetic layer, the soft magnetic layer and the semi soft magnetic layer, it should be appreciated that these layers may be arranged in any order.

It should be appreciated that any number of soft magnetic layer(s) and/or semi soft magnetic layer(s) may be provided in the magnetoresistance devices of various embodiments. In addition, it should be appreciated that additional hard magnetic layer(s) may also be provided in the magnetoresistance devices of various embodiments.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A magnetoresistance device comprising:
a hard magnetic layer and a soft magnetic layer arranged one over the other,
wherein the soft magnetic layer comprises a stack structure, the stack structure comprising a first layer and a second layer arranged one over the other,
wherein the first layer has a first damping factor and the second layer has a second damping factor, the first damping factor is selected to be lower than the second damping factor.

2. The magnetoresistance device of claim 1, wherein the first layer comprises a material selected from the group consisting of cobalt, iron, nickel, boron, nitrogen, and an alloy comprising at least one of cobalt, iron or nickel.

3. The magnetoresistance device of claim 1,
wherein the first layer comprises at least one first bilayer structure, and
wherein a layer of the at least one first bilayer structure comprises a material selected from the group consisting of cobalt, iron, boron, and nickel, and another layer of the at least one first bilayer structure comprises a material selected from the group consisting of palladium, platinum and nickel.

4. The magnetoresistance device of claim 3, wherein a thickness of the layer of the at least one bilayer structure is between about 0.2 nm and about 1 nm.

5. The magnetoresistance device of claim 1, wherein the second layer comprises a material selected from the group consisting of iron-platinum, cobalt-platinum, cobalt-palladium and an alloy comprising at least one of cobalt, iron, nickel, platinum or palladium.

6. The magnetoresistance device of claim 1,
wherein the second layer comprises at least one second bilayer structure, and
wherein a layer of the at least one second bilayer structure comprises a material selected from the group consisting of cobalt, iron and nickel and another layer of the at least one second bilayer structure comprises palladium, nickel or platinum.

7. The magnetoresistance device of claim 6, wherein a thickness of the layer of the at least one second bilayer structure is between about 0.2 nm and about 1 nm.

8. The magnetoresistance device of claim 1, wherein the stack structure comprises a plurality of the first layers and a plurality of the second layers such that each first layer and each second layer are arranged alternately.

9. The magnetoresistance device of claim 1, further comprising a third layer between the first layer and the second layer, wherein the third layer is configured to control the exchange coupling between the first layer and the second layer.

10. The magnetoresistance device of claim 8, further comprising a plurality of third layers, each third layer being arranged between each first layer and each second layer, wherein each third layer is configured to control the exchange coupling between each first layer and each second layer.

11. The magnetoresistance device of claim 1,
wherein the hard magnetic layer comprises at least one material selected from the group consisting of iron, platinum, cobalt, palladium, germanium, phosphorous, nickel and an alloy comprising at least one of iron, platinum, cobalt, palladium, germanium, phosphorus or nickel, or
wherein the hard magnetic layer comprises at least one third bilayer structure, wherein a layer of the at least one third bilayer structure comprises a material selected from the group consisting of cobalt, nickel and iron, and another layer of the at least one third bilayer structure comprises a material selected from the group consisting of platinum, palladium and an alloy comprising at least one of platinum or palladium.

12. The magnetoresistance device of claim 1, further comprising a spacer layer disposed between the hard magnetic layer and the soft magnetic layer.

13. The magnetoresistance device of claim 12, wherein the spacer layer comprises a material selected from the group consisting of a conductive and non-magnetic material, a non-conductive and non-magnetic material, and an insulator material.

14. The magnetoresistance device of claim 12, further comprising a first spin-polarizing layer disposed between the hard magnetic layer and the spacer layer.

15. The magnetoresistance device of claim 12, further comprising a second spin-polarizing layer disposed between the soft magnetic layer and the spacer layer.

16. The magnetoresistance device of claim 1, wherein the hard magnetic layer and the soft magnetic layer are respectively configured such that their respective magnetization orientation is oriented in a direction substantially perpendicular to a plane defined by an interface between the hard magnetic layer and the soft magnetic layer.

17. The magnetoresistance device of claim 1, wherein the hard magnetic layer and the soft magnetic layer are respectively configured such that their respective magnetization orientation is oriented in a direction substantially parallel to a plane defined by an interface between the hard magnetic layer and the soft magnetic layer.

18. The magnetoresistance device of claim 1, wherein the hard magnetic layer and the soft magnetic layer are respectively configured such that their respective magnetization orientation is oriented in a direction at an angle to a plane defined by an interface between the hard magnetic layer and the soft magnetic layer.

19. The magnetoresistance device of claim 1, further comprising a second soft magnetic layer.

20. The magnetoresistance device of claim 19, wherein the second soft magnetic layer has a damping factor lower than each of the hard magnetic layer and the soft magnetic layer.
